(19) United States
(12) Patent Application Publication
(10) Pub. No.: US 2012/0274447 A1
(43) Pub. Date: Nov. 1, 2012

(54) FLASHLIGHT ALARM

(76) Inventor: BRIAN K. HESS, Westerville, OH (US)

(21) Appl. No.: 13/459,796

(22) Filed: Apr. 30, 2012

Related U.S. Application Data
(60) Provisional application No. 61/480,444, filed on Apr. 29, 2011.

(51) Int. Cl. G08B 5/22

(52) U.S. Cl. 340/8.1; 340/6.1

(57) ABSTRACT

A portable alarm system is disclosed. The alarm system includes an enclosure configured as a flashlight. The enclosure includes at least one illumination element, at least one activation element, and at least on of a wireless transceiver, the transceiver configured to receive an activation signal and transmit an alarm signal.

### CROSS-REFERENCE TO RELATED APPLICATIONS

This application claims priority to U.S. Provisional Patent Application 61/480,444 filed on Apr. 29, 2011, the contents of which are hereby incorporated by reference in its entirety.

### BACKGROUND

Flashlight alarm devices come in many different shapes and sizes. Some include automatic illumination based on motion of the flashlight itself not motion adjacent the flashlight. The basic idea behind these prior art flashlights is to detect when a firefighter or other operator is up and moving, not to detect something moving around an outside perimeter of the flashlight, such as an intruder or animal.

Other flashlight alarm devices utilize a mechanical rod that passes through the unit and when withdrawn by opening or closing a door or window electrical contacts are open and closed which in turn triggers a bell and light. Typically, these units do not have a method of remotely activating and deactivating the units. Other mechanical means of actuating the alarm portion are also used, such as, a spring-loaded rod that is located at the backside of a typical flashlight. When the unit is set in an upright position the spring-loaded rod or (plunger) would be held in place and when the unit is knocked over in electrical contact would be made the attached light and sounding device would operate.

Finally, other known devices may include a basic flashlight with a removable pin, which is used to activate a light and a separate siren. These devices may also include a spray (mace or pepper), belt clip and Velcro® for attaching it to an operator as they are walking or jogging. This known flashlight may be upgraded by adding other modules such as a smoke detector, a motion detector and external contacts for windows and doors. However, these devices all fail to provide remote arming and disarming with internal vibration sensors.

Therefore, what is needed is a mobile alarm device in the form of a unique flashlight enclosure having remote activation and deactivation capabilities, as well as two way wireless communications with a remote sensor.

### SUMMARY

The present disclosure relates to a new and unique flashlight with a mobile alarm for security system that is simple, portable and expandable. The flashlight alarm device may contain a transceiver for communicating with at least one remote device, such as, but not limited to a key-fob and at least one remote sensor. The remote device may be used to activate and deactivate the unit, as well as the at least one remote sensor. The unique device is constructed in a unique enclosure to facilitate the light, as well as, at least one passive infrared (PIR) sensor or detector configured on at least one surface of the device.

The device may utilize the PIR to detect motion from an external source. Additionally, the unit may include an accelerometer to detect movement of the unit itself. The device may be configured to activate and deactivate an illumination feature remotely and may include a mechanism for timing how long a bell, siren and illumination feature stay on.

The device may be configured to recharge batteries through any known method, such as, but not limited to conventional electrical circuits and solar power. The device may include the remote arming and disarming feature of an internal vibration sensor, such as the accelerometer.

The device may be configured with various support features, such as, but not limited to spikes extending from a front face for positioning the device in an upright position with a strobe extending from a second end, a clip for attaching to an operator or other structure and a magnet for affixing to a metal structure.

The device may be configured with at least one selectively retractable and extendable electrode, such as, but not limited to a personal security electric shock electrode. The electrode may be configured to send an electrical current to an individual or animal during an unwanted confrontation.

The device may include unique activation features, such as, but not limited to, the key-fob remote, a numbered keypad, a finger print scan, a housing motion detector, a manual switch or a combination thereof, and any other known activation element. The numbered keypad may be preprogrammed with a specific number sequence for both activation and deactivation of the alarm system.

The exemplary flashlight alarm system remote sensor may include a pointed first end, a cylindrical second end configured with at least a strobe and siren and a mid-section that may contain the internal components, such as but not limited to a transceiver.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are exemplary and are not intended to be exhaustive or otherwise limit or restrict the claims to the precise forms and configurations shown in the drawings and disclosed in the following detailed description.

FIG. 1 illustrates an exemplary flashlight alarm system with remote sensor; and

FIG. 2 illustrates an exemplary flashlight alarm with keypad activation;

FIG. 3 illustrates an exemplary flashlight alarm with fingerprint recognition;

FIG. 4 illustrates an exemplary flashlight alarm with retractable electrode;

FIG. 5 illustrates an exemplary flashlight alarm with springing electrode;

FIG. 6 illustrates an exemplary flashlight alarm with solar recharging system and magnet;

FIG. 7 illustrates an exemplary flashlight alarm system key fob;

FIG. 8 illustrates an exemplary flashlight alarm system remote sensor with rotating siren alarm; and

FIG. 9 illustrates an exemplary flashlight alarm system remote sensor with video capture element.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Reference in the specification to “an exemplary illustration” and “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

According to various exemplary illustrations described herein, a device and method are disclosed. Specifically, an exemplary mobile flashlight alarm unit and system is disclosed. The unit may be housed in a unique and strong enclosure that would resemble a flashlight. The unit may be configured to communicate with at least one portable sensor and at least one portable handheld control device. The unit may include an illumination element configured at a first end of the device that can be pointed at the area the user wishes to illuminate. The unit may include a second end having a strobe and siren alarm for alerting to an intruder. The unit may include a rechargeable battery for powering the illumination element and electronic control system for activation and deactivation of the mobile alarm system.

The at least one portable sensor may be wireless and include any known sensor, such as, but not limited to motion detectors, thermal detectors, noise detectors and smoke detectors. The at least one portable sensor may include a transceiver for communication with the exemplary mobile flashlight alarm unit and in combination with the remote sensor and handheld control device makeup a portable alarm system.

The transceivers may also be configured to receive and transmit any known communication signal between the at least one portable sensor and the exemplary mobile flashlight alarm unit. The transceivers may include a low power radio, a Wi-Fi device, a Bluetooth device, or other such short-range wireless communication device. Furthermore, the transceiver may also be configured with a cellular modem for longer-range communications with various cellular networks using known communication protocols. Preferably, the transceiver may communicate between the mobile flashlight alarm, the at least one portable sensor and with the handheld control device through any known communication interface. Additionally, at least one of the portable sensor and the mobile flashlight alarm unit may include an intelligent communications interface configured internally to the outer surfaces of each. The intelligent communications interface may include an intelligent communications board (not illustrated) and a radio component (not illustrated) for short-range and long-range communications. The intelligent communications interface may be any suitable interface that may receive alarm signal and translate the alarm signal to wireless digital data. For example, the intelligent communications interface may have a microprocessor board (not illustrated) that is programmed to receive alarm signals and translate any desired portion of the alarm signal to wireless digital data.

The intelligent communications interface may be programmed to translate any desired alarm signal to any suitable type of wireless digital data for further transmission as discussed further herein. For example, the wireless digital data may comprise textual digital data such as short message service (SMS) type data. SMS was created when it was incorporated into the Global System for Mobiles (GSM) digital mobile phone standard. That technology, which is now widely available and used, provides the ability to send and receive text messages to and from, for example, mobile telephones. The text can comprise words or numbers or an alphanumeric combination. When the wireless digital data comprises SMS type data, the intelligent communications interface may convert the alarm signal to a text based command set, such as an AT command set, for SMS type transmission. In another example, the alarm signal may be converted to multimedia messaging service (MMS) type data or general packet radio services (GPRS) type data. One of ordinary skill in the art understands that any type of wireless digital data can be used and that the radio component (not illustrated) is selected to utilize one or all of these data packet transport methods. In other words, the type, configuration and selection of the radio component (not illustrated) depend in part on the data packet method used to transport the wireless digital data across third party networks (e.g. Sprint, Verizon, Nextel, AT&T, etc.). These third party networks employ various types of wireless network solutions, including, but not limited to, Universal Mobile Telecommunications Systems (UTMS), Code Division Multiple Access (CDMA) Wideband Division Multiple Access (W-CDMA), General Packet Radio Services (GPRS) and High-Speed Downlink Packet Access (HSDPA) to name a few. The mobile flashlight alarm system, and more specifically, the intelligent communications interface and the radio component, are configured to be compatible with any data packet transport method or any wireless network solution.

The intelligent communications interface radio component may also be configured internally to the outer surfaces, as discussed above. The radio component may be any suitable type of radio. The radio is selected to be capable of transmitting and receiving the desired type of wireless digital data. For example, the radio may be a cell phone that may transmit and receive SMS type data. The radio may transmit the wireless digital signal to any suitable type of service station as discussed further herein.

Additionally, the intelligent communications interface may also include a global positioning satellite (GPS) component that through the radio component may be activated by the user and emergency personnel for tracking the system in the case of emergency. When activated, the GPS provides location information for at least one component of the mobile flashlight alarm system. It is appreciated that other tracking devices or services, besides GPS, may be used. In one exemplary approach, the GPS component (not illustrated) may use a GPS broadcast signal received from one or more GPS satellite broadcast systems. Generally, the GPS component monitors a location of the flashlight alarm system to provide location information to a remote device in response to a security event. For example, the microprocessor (not illustrated) may periodically receive location information from a GPS receiver (not illustrated) in the form of longitude and latitude coordinates. The microprocessor (not illustrated) may be configured to initiate an alert in response to a change in the received location information that indicates an unanticipated movement of any component of the flashlight alarm system. Furthermore, the microprocessor may be configured to relay location information from the GPS receiver to a remote device through the intelligent communications interface.

It may be used to notify a monitoring service of an emergency and transmit the GPS to coordinate and aid in the location of the person(s) in need of assistance. Constantly receiving the location from the GPS receiver may quickly deplete a power source. Therefore, the system may be configured so that the GPS receiver is selectively enabled to conserve the power source. Additionally, a separate power source may be provided for the GPS and radio package that may allow the user to still send an emergency message to the monitoring service even when an illumination power source has been depleted. The power source may be any known power source that is configured to charge at least one battery. A plurality of batteries may be used to power the illumination element and the intelligent communications interface. A charging system may be configured to charge the plurality of batteries depending on the application.

The illumination element may include an infrared sensor or at least one conventional light. The conventional light may include at least one of a light emitting diode (LED), an incandescent bulb, and a high-intensity discharge bulb, as the illumination element and/or for indicating a charge state of a battery. Additionally, the illumination element may also indicate a selected mode of operation.

The infrared sensor may include at least one passive infrared (PIR) sensor or detector, which may be used to detect motion and or body heat in a general area around the unit, and may be directed to illuminate an area with passive infrared light. The sensor may be configured on the flashlight alarm housing and the portable sensor in any known configuration. The sensor may also swivel to a predetermined direction depending on the application.

The unit may include a selector switch for determining a mode of operation, such as steady light, flashing light, delayed motion sensor, instant motion sensor. A loud sounding device, such as, but not limited to a piezoelectric sound generating type device, may be used alone or in combination with the illumination element to alert the user when motion has been detected.

The unit may act and appear for the most part as a normal rechargeable dual beam flashlight. A user may be able to select between the modes of operation through at least one push button, such as, but not limited to a sealed or multiple sealed push buttons. The push button may turn on the light or flash the light on and off to attract attention. In one exemplary method the user may set the flashlight down (on a floor, staircase, table, bookshelf, etc.) and point it into a room or hallway they wish to monitor for movement. Then select the appropriate mode of operation (instant or delayed), depending on if they needed to pass by the detection pattern of the unit when turning it on and off or silent.

When in the instant mode, the user may have a predetermined time to place the unit down on a steady surface after it was first placed into the instant mode. When in the instant mode, the unit may emit a loud siren sound and turn the light on as soon as any motion was detected by the PIR motion detector. The unit may continue to sound for a desired time or until it was turned off by pressing the proper buttons on the unit or the key fob. The use of the key fob for activation and operation of the device may allow for ease of use, which may provide greater security since an intruder or animal could not turn off the device without access to the key fob.

In the delayed mode or set able mode, the unit may operate much the same as it did in the instant mode, but when motion is first detected by the PIR motion detector, the unit may produce a beeping noise and flash the light at a slow rate (once per second) to allow time for the user to deactivate the unit. If it is not deactivated within a predetermined time, the unit may emit the loud siren sound and turn the light on steady.

A vibration sensor, such as, but not limited to a mechanical or microelectro mechanical (MEM's) based sensor may be used to generate an instant alarm if any component from the system is picked up while it is armed. Further, the motion may also be used as a method to turn on the light simply picking the flashlight up, thus not having to locate the ON button in an emergency situation.

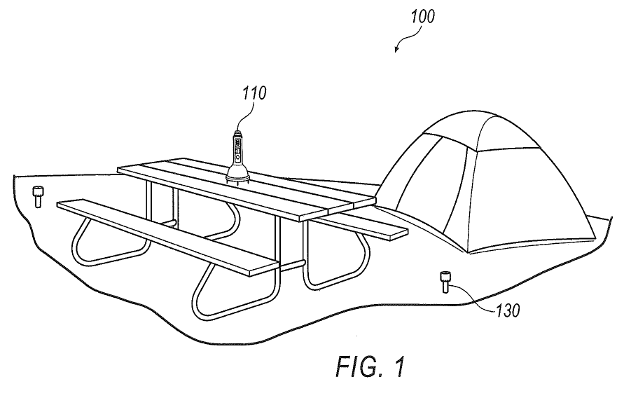

Turning now to the exemplary illustrations, FIG. 1 illustrates an exemplary mobile flashlight alarm system 100 configured at a campsite. As illustrated, the exemplary mobile flashlight alarm system includes at least one mobile flashlight alarm unit 110 and at least one portable sensor 130, illustrated as positioned in the ground. The mobile flashlight alarm system 100 may be configured in various other areas where a predetermined perimeter may be established, such as, but not limited to a hotel room, a pavilion area, a dorm room, out building or other type of structure. As discussed above, at least one of the exemplary flashlight alarm unit 110 and the portable sensor 130 includes an intelligent communications interface (not illustrated), which may allow wireless communication between the flashlight alarm unit 110, portable sensor 130 and at least one of a GPS service, an alarm monitoring service and an emergency service provider. The mobile flashlight alarm unit 110 and the portable sensor may include various features, which will be discussed in greater detail below, and are not limited to one specific illustration or combination of features.

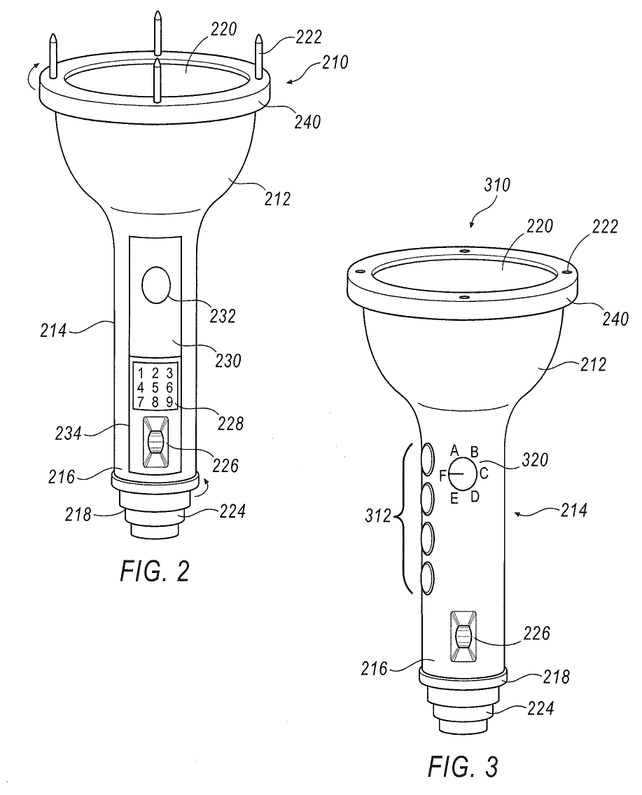

FIG. 2, illustrates an exemplary mobile flashlight alarm unit 210, the unit 210 may include a housing 214 having a first end 212 and a second end 216. The housing 214 may enclose the intelligent communications interface as discussed above as well as at least one power source, such as, but not limited to a rechargeable battery. As illustrated, the flashlight alarm unit 210 may include an illumination element 220 at the first end 212 and an additional illumination element 224 at the second end 216. The additional illumination element 224 may be a rotating light element, a selectively variable light element, a constant light element or a strobe light element. A rotatable switch 218 may be configured at the second end 216 for selecting the desired type and speed of the additional illumination element 224. The switch 218 may selectively rotate to a predetermined position, which corresponds to the specific light element.

The mobile flashlight alarm unit 210 may also include at least one supporting element 222 that may be configured at the first end 212 on a supporting ring 240. The at least one supporting element 222 may be adjustable and selectively retractable to support the flashlight alarm unit on various surfaces, such as, but not limited to a hard or a soft surface. The supporting element 222 may be rigid and may include various tips such as a point for stability. The supporting ring 240 may be rotatively engaged with the first end 212 and may include a shock resistant material (not illustrated). The supporting ring 240 may be configured to attach a protective lens (not illustrated) over the illumination element 220.

The exemplary mobile flashlight alarm unit 210 may be activated and deactivated through the use of touch screen 228. The touch screen 228 may include an interface where various features, such as a motion sensor 226, may be selected for use. The touch screen 228 may be, but is not limited to a simple alpha-numeric keypad or an interactive selection screen configured to communicate with the microprocessor discussed above. The touch screen 228 may allow an operator to set an associated timer or intensity of the illumination element 220, 224. Additionally, the touch screen 228 may allow the operator to activate and deactivate the portable sensors 130, as well as, the various communication connections of the communications interface, as discussed above.

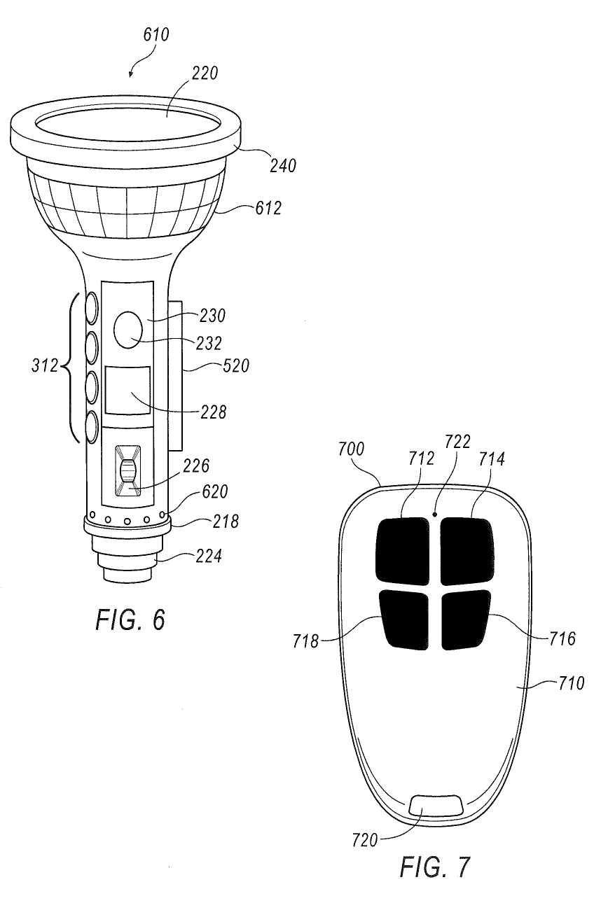

The motion sensor 226 may be configured on the housing 214 and may provide an indication of an intruder or animal approaching the area. The motion sensor 226 may detect at least one of heat or movement to activate at least one of the illumination elements 220, 224 and an audible indicator 620 (see FIG. 6). As discussed above, and illustrated in FIG. 6, the audible indicator 620 may be a piezoelectric noise element that is interconnected with the illumination elements 220, 224 or it may be a conventional siren loud speaker (not illustrated).

A cover 230 may be included for protecting the motion sensor 226 and the touch screen 228. The cover 230 may include a button 232 for locking the cover 230 into place and to aid in sliding the cover 230 along tracks 234 configured in the housing 214. The tracks 234 and the cover 230 may be configured to slide longitudinally or horizontally, depending on the application. The cover 230 may also be configured as a hinged door that flips up, down or side to side for covering and protecting potentially damageable features.

FIG. 3 illustrates an exemplary mobile flashlight alarm unit 310 with the at least one supporting element 222 in the retracted position. The flashlight alarm unit 310 illustrates the use of at least one finger print reader 312 for the activation and deactivation of the flashlight alarm unit 310. The fingerprint reader 312 may be initialized using the touch screen 228 to selectively engage and disengage the various features. The finger print reader 312 may allow an operator to quickly select a specific illumination element 220, 224 by selecting a specific finger print reader 312, which is illustrated as a plurality of finger print readers. Additionally, a selection dial 320 may also be used adjustably selecting a specific intensity of the illumination elements 320, 324 and/or the volume of the audible indicator 620. The selection dial 320 may be similar to the rotating switch 218 in that both select a specific intensity and interval for the illumination elements 220, 224 and the audible indicator 620. However, it should be realized that either may be used independently or simultaneously depending on the application.

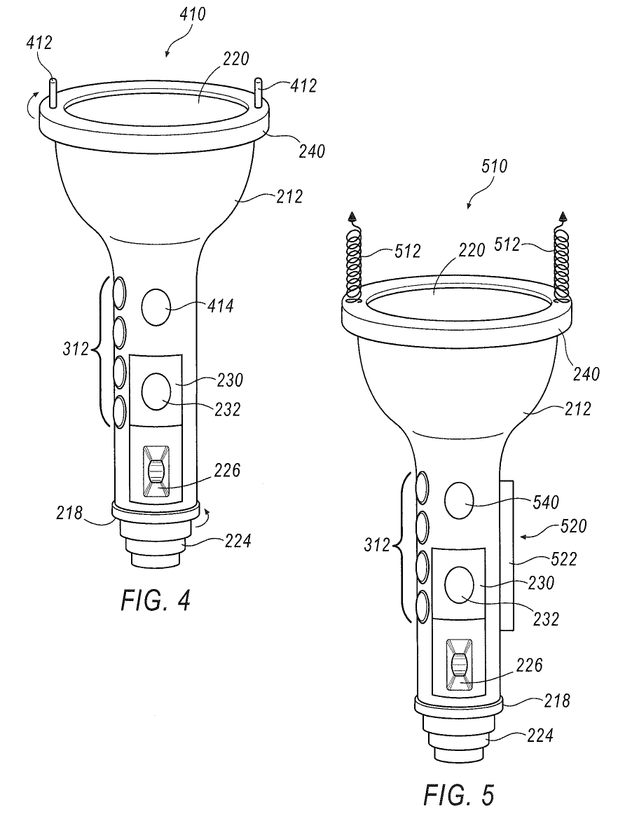

FIGS. 4 and 5 illustrate exemplary mobile flashlight alarm units 410, 510 having at least one selectively retractable and extendable electrode 412, 512. The electrode 412 may extend from the supporting ring 240 and may be configured to selectively retract into the supporting ring 240. The extension and retraction of electrode 412 may be a function of rotating the supporting ring 240 in either direction. Electrode 512 may be a springing type electrode that is retained in the ring 240 and may be selectively released and engaged by depressing button 540. Additionally, an auxiliary release element (not illustrated), such as compressed air or small explosive may be used to propel the electrode 512 into an intended target, such as, but not limited to an intruder or animal.

The electrode 412 may be, but is not limited to a personal security electric shock electrode that is interconnected with the previously discussed power source. Additionally, the electrodes 412, 512 may be connected to a transformer (not illustrated) for altering the power source to a higher intensity. The electrodes 412, 512 may be configured to send an electrical current to an individual or animal during an unwanted confrontation. The electrode 412, 512 may be activated by depressing button 414 when the electrode 412 is directly connected to an intruder or animal.

Additionally, the exemplary mobile flashlight alarm unit 510 includes an alternative mounting element 520. The alternative mounting element may be, but is not limited to a magnet, a clip or other such mounting element. As illustrated, the alternative mounting element 520 is a magnet configured in a housing 522. It is contemplated that any known type of mounting element may be used provided the flashlight alarm unit 510 is visible and heard to warn of an intrusion to the perimeter, as discussed above.

FIG. 6 illustrates an exemplary mobile flashlight alarm unit 610 having an integrated solar panel 612 configured to harness the ambient light for a power source. The solar panel 612 illustrated in FIG. 6 is merely demonstrative as to one position for the panel 612 and in no way limits the panel 612 configuration. The solar panel 612 may work in conjunction with the previously discussed charging element (not illustrated), and may work simultaneously or independently to charge the at least one batteries, discussed above. Additionally, the exemplary flashlight alarm unit 610 may include at least one audible indicator 620 outlet where the sound may be heard without the restrictions of the housing or a cover configured on the illumination elements 220, 224. The audible indicator 620 outlet may be a simple aperture with a screen or other protective element to keep debris and contaminants out of the internal components configured within the housing 214. The solar panel 612 may be of any known solar panel and may be configured on the housing surface, 614 on the support ring 240, as an auxiliary attachment (not illustrated) or as a folding element that extends from the housing (not illustrated).

FIG. 7 illustrates an exemplary portable handheld control device 700. The handheld control device 700 is illustrated as a key fob, but may also be configured as an application for a wireless phone, or other handheld device. As illustrated, the control device 700 includes a housing 710 configured to contain at least one intelligent communications interface component as discussed above for communication with any one of the exemplary mobile flashlight alarm units 110, 210, 310, 410, 510, 610, as discussed above. The control device 700 may include a plurality of control buttons, such as an activation button 712, a deactivation button 714, an initialization button for syncing at least one portable sensor 130, 810, 910 with the flashlight alarm unit and a panic button 718 configured to trip or set off the alarm system. Additionally, the portable handheld control device 700 may include an aperture 720 for carrying the device 700 with a lanyard (not illustrated) or other such device. The portable handheld control device 700 may also include at least one illumination element 722 to indicate when one of the buttons 712, 714, 716, 718 is depressed or engaged.

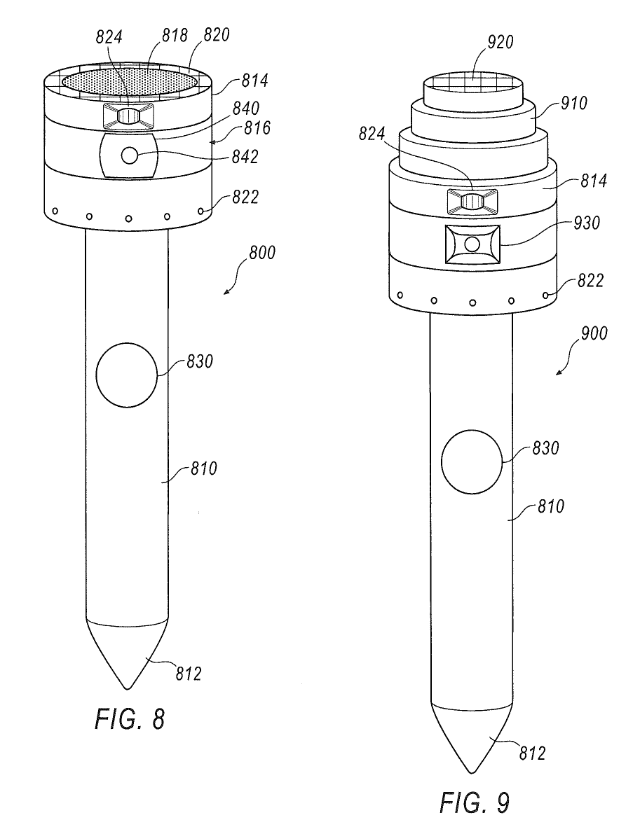

FIGS. 8 and 9 illustrate exemplary mobile flashlight alarm system 100 sensors 130. Specifically, FIG. 8 illustrates a portable alarm sensor 800 configured with a shaft element 810 having a pointed or staked first end 812 with a cylindrical second end 814. The shaft element 810 may include an internal power source (not illustrated) such as a battery. The battery, like the previously discussed batteries, may be charged using a conventional power connection, as with the previously discussed flashlight alarm unit, or it may include at least one solar panel 820 configured on at least one surface of the portable sensor 800. The cylindrical second end 814, may include at least one motion sensor 824 that may be configured to swivel and rotate about the second end 814, and is in no way limited to a specific position. The cylindrical second end 814 may include a rotating illumination element 842 that is configured in a circumferential track 816. The track 816 allows the illumination element 842 to rotate around the shaft 810 that extends into the cylindrical second end 814.

Additionally, the illumination element 842 may include an audible generation element 840 that is configured adjacent the illumination element 842 and rotates simultaneously with the element 842. However, it should be known that a speaker 818 may also be included to amplify a sound being emitted from the portable alarm sensor 800. An activation button 830 may be configured on at least one portion of the portable alarm sensor 800 and is illustrated on the shaft 810 in FIGS. 8 and 9. As previously discussed, the portable sensors 130, 800, 900 may be used to establish a perimeter around a predetermined area for security. The sensors 130, 800, 900 may include the electronic interface, as discussed and a GPS transceiver for locating the sensor 130, 800, 900 and the flashlight alarm system 100, in a time of need.

With specific reference to FIG. 9, an alternative configuration of a portable alarm sensor 900 is shown. The sensor 900 is illustrated with a strobe 910 configured on a top surface of the cylindrical second end 814. Additionally, a solar panel 920 is illustrated as being configured on a top surface of the strobe 910. The cylindrical second end 814 may also include at least one camera 930 for capturing an image of the intruder or animal, as previously discussed.

Additionally, both FIGS. 8 and 9 are illustrated with a plurality of apertures 822 configured on the cylindrical second end 814. The apertures 822 may be configured to dispense a repellant spray from a canister configured in the portable sensor 800, 900. The spray may be used as deterrent to warn and possible prevent an intruder or animal from entering the perimeter. The spray may be a pepper spray, an animal odor spray, a bear repellant or any other known deterrent spray.

It will be appreciated that the system and methods described herein have broad applications. The foregoing embodiments were chosen and described in order to illustrate principles of the methods and apparatuses as well as some practical applications. The preceding description enables others skilled in the art to utilize methods and apparatuses in various embodiments and with various modifications as are suited to the particular use contemplated. In accordance with the provisions of the patent statutes, the principles and modes of operation of this invention have been explained and illustrated in exemplary embodiments.

It is intended that the scope of the present methods and apparatuses be defined by the following claims. However, it must be understood that the exemplary embodiments may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claim. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. It should be understood that the exemplary embodiment is capable of modification and variation and is limited only by the following claims.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Reference in the specification to “one example,” “an example,” “one approach,” or “an application” means that a particular feature, structure, or characteristic described in connection with the example is included in at least one example. The phrase “in one example” in various places in the specification does not necessarily refer to the same example each time it appears.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements.

Moreover, the foregoing illustrations are illustrative, and no single feature or element is essential to all possible combinations that may be claimed in this or a later application. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A portable alarm system, comprising:
an enclosure configured as a flashlight,
at least one illumination element, the illumination element configured on at least one of a first end and a second end;
at least one activation element; and
at least on of a wireless transceiver, the transceiver configured to receive an activation signal and transmit an alarm signal.

2. The portable alarm system of claim 1, wherein the illumination element is at least one of an infrared sensor and a conventional light.

3. The portable alarm system of claim 1, further comprising: a handheld remote configured to activate and deactivate the alarm system.

4. The portable alarm system of claim 1, further comprising: at least one of a GPS package and a cellular radio package, wherein the package includes a separate power source.

5. The portable alarm system of claim 1, further comprising: at least one portable power source, wherein the power source is at least one of internal and external.

6. The portable alarm system of claim 5, wherein the power source is at least one of rechargeable or conventional, such that the rechargeable power source is configured to be at least one of solar and conventional.

7. The portable alarm system of claim 1, further comprising: at least one vibration sensor configured within the housing.

8. The portable alarm system of claim 7, wherein the vibration sensor is at least one of a mechanical sensor and a microelectromechanical (MEM's) sensor.

9. A portable alarm system, comprising:
at least one flashlight alarm base unit including a communications interface, wherein the communications interface is configured to transmit and receive a position of at least one portable sensor to at least one handheld device; and
at least one finger print recognition element, wherein the recognition element is configured to activate and deactivate at least one feature.

10. The portable alarm system of claim 9, further comprising at least one of a GPS package and a cellular radio package, wherein the package includes a separate power source.

11. The portable alarm system of claim 9, further comprising at least one of a motion sensor and a thermal sensor.

12. The portable alarm system of claim 9, further comprising: at least one vibration sensor configured within the housing.

13. The portable alarm system of claim 9, wherein the portable sensor is a ground stake configured with at least one of an illumination element, an audible tone, a camera element, a strobe, a solar panel, a communications interface and at least one repellent emitting aperture.

14. The portable alarm system of claim 9, further comprising at least on remote control device.

15. A flashlight alarm system, comprising:
at least one flashlight housing configured to contain at least one communications transceiver; and
at least one portable sensor configured as a stake, the stake including at least one communications transceiver.

16. The flashlight alarm system of claim 15, further comprising at least one of a motion sensor and a thermal sensor.

17. The portable alarm system of claim 15, further comprising: at least one vibration sensor configured within the housing.

18. The portable alarm system of claim 15, wherein the portable sensor is a ground stake configured with at least one of an illumination element, an audible tone, a camera element, a strobe, a solar panel, a communications interface and at least one repellent emitting aperture.

19. The portable alarm system of claim 15, further comprising at least on remote control device

20. The portable alarm system of claim 15, wherein the intelligent communications interface include at least one selectively activated global positioning system (GPS), the GPS configured to reduce power consumption when not activated.
